(19) United States
(12) Patent Application Publication
(10) Pub. No.: US 2025/0119739 A1
(43) Pub. Date: Apr. 10, 2025

(54) Providing Secure Wireless Network Access

(71) Applicant: Oracle International Corporation, Redwood Shores, CA (US)

(72) Inventor: Menachem Joseph Baranowsky, Ontario (CA)

(73) Assignee: Oracle International Corporation, Redwood Shores, CA (US)

(21) Appl. No.: 18/482,479

(22) Filed: Oct. 6, 2023

(51) Int. Cl. H04W 12/08; H04W 12/041; H04W 12/06; H04W 12/69

(52) U.S. Cl. CPC H04W 12/08; H04W 12/041; H04W 12/06; H04W 12/69

(57) ABSTRACT

Techniques for securely accessing a computer network are described. An access provider sends network access credentials to an access management device. Upon receiving the credentials, the access management device generates an image key that embeds the credentials. The access management device then presents the image key to a client device. The client device receives the image key and extracts the credentials from within the image key. The client device transmits the credentials to the access provider with an authentication request. Based on the credentials included with the authentication request, the access provider attempts to authenticate the client device. If authentication is successful, the access provider grants the client device access to the wireless network and resources accessible via the wireless network.

### TECHNICAL FIELD

The present disclosure relates to computer networks. In particular, the present disclosure relates to a mechanism for securely accessing a wireless computer network.

### BACKGROUND

Public internet access has been made available in many business, education, and other organizational environments. Public internet access points are abundant in business establishments, for instance, because business establishments often provide internet access as an amenity to their customers. Public internet access is frequently made available through a wireless computer network. For example, coffee shops, restaurants, and hotels frequently offer “free Wi-Fi” to their clientele. Access to these wireless computer networks is often severely under protected. Communications sent from a device through an under-protected wireless computer network may be highly vulnerable to malicious access. These communications might include login credentials, personal information, financial data, or other sensitive information. The individuals who connect to these wireless computer networks may be totally unaware of the danger. The entities that administer these wireless computer networks may lack an understanding of the risk, or they simply may not possess the administrative resources that are necessary to provide adequate security for every individual who wishes to use the public internet access. Moreover, even when appropriate security precautions have been taken, security vulnerabilities remain when connecting to public wireless networks.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for providing secure network access in accordance with one or more embodiments;

FIG. 3 illustrates an example set of operations for managing secure network access in accordance with one or more embodiments;

FIG. 4 illustrates an example set of operations for requesting network access in accordance with one or more embodiments;

FIG. 5 illustrates an example set of operations for securely accessing a computer network in accordance with one or more embodiments;

FIG. 6A illustrates an example of a system for secure computer network access in accordance with one or more embodiments;

FIG. 6B illustrates an example embodiment of an image key in accordance with one or more embodiments; and

FIG. 7 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

The following table of contents is provided for the reader's convenience and is not intended to define the limits of the disclosure.
1. GENERAL OVERVIEW
2. SYSTEM ARCHITECTURE
3. OPERATIONS for PROVIDING SECURE NETWORK ACCESS
4. OPERATIONS for MANAGING SECURE NETWORK ACCESS
5. OPERATIONS for REQUESTING SECURE NETWORK ACCESS
6. COMBINED OPERATIONS for SECURE NETWORK ACCESS
7. EXAMPLE EMBODIMENT
8. COMPUTER NETWORKS and CLOUD NETWORKS
9. MICROSERVICE APPLICATIONS
   9.1 TRIGGERS
   9.2 ACTIONS
10. ADVANTAGES of SECURE NETWORK ACCESS
11. HARDWARE OVERVIEW
12. MISCELLANEOUS; EXTENSIONS

### 1. General Overview

One or more embodiments embed user credentials for accessing a wireless computer network into an image key for distribution to client devices. An access management device obtains credentials that may be used for gaining access to a wireless network. The access management device may obtain the credentials from a credentials generator. The credentials generator may be implemented on an access provider or on the access management device itself.

The access management device embeds the credentials in an image key. An image key that embeds credentials, as referred to herein, includes an image key that includes information that may be used to compute or access the credentials. In other words, a hash function, translation function, or other function when applied to the image key results in computing the credentials. Alternatively, or additionally, the hash function, translation function, or other function when applied to the image key results in computing a reference or link for accessing the credentials. The access management key displays or prints the image key for providing access to the wireless network.

A client device accesses the image key displayed or printed by the access management device. As an example, the client device scans the image key using a camera. A credentials extractor, implemented on the client device, extracts the credentials embedded in the image key. The credentials extractor may execute a function on the image key to compute the credentials. Alternatively, or additionally, the credentials extractor may execute a function on the image key to compute a reference or link. The reference or link is accessed to obtain the credentials. The client device provides the extracted credentials to the access provider to gain access to the wireless network, and resources accessible via the wireless network.

One or more embodiments described in this specification and/or recited in the claims may not be included in this General Overview section.

### 2. System Architecture

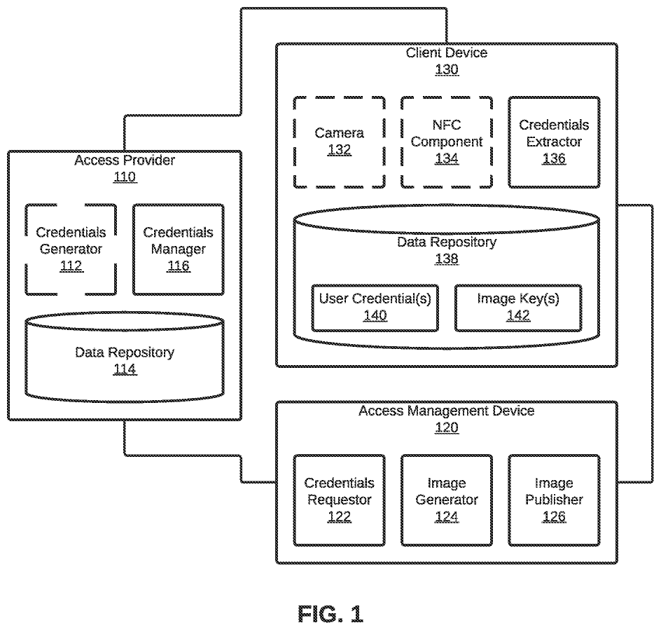

FIG. 1 illustrates a system 100 in accordance with one or more embodiments. System 100 provides a mechanism for securely accessing a computer network. The term “computer network” generally refers to connectivity between nodes. The nodes of a computer network are connected by links. Links may be physical links or wireless links. In an embodiment, the computer network may be a wireless computer network. A “wireless computer network” may generally refer to any computer network that includes at least one link that is not a physical link. A wireless computer network may also be referred to more simply as a “wireless network.” General examples of wireless networks include wireless personal area networks (WPANs), wireless local area networks (WLANs), cellular networks, satellite networks, internet of things (IoT) networks, and others. More particular examples of wireless networks are those that incorporate Wi-Fi, Bluetooth, NFC, 4G, 5G, Z-Wave, UWB, and other communication protocols. A wireless network may incorporate multiple communication protocols. Furthermore, a wireless network may accord to a wide variety of network security protocols. Examples of network security protocols include internet protocol security (IPsec), secure socket layer (SSL), transport layer security (TLS), secure shell (SSH), Wi-Fi protected access (WPA/WPA2/WPA3), and many others. Communications to and from nodes of system 100 may or may not be encrypted. Encrypted communications may be encrypted according to one or more encryption keys. The encryption key(s) used to encrypt a communication may or may not be a pre-shared encryption key. A “pre-shared encryption key” may generally refer to an encryption key that is shared between two or more nodes prior to some communication between the two or more nodes. The characteristics of any encryption key(s) used to encrypt communications and the way that encryption keys are shared between nodes may vary according to a variety of factors such as communication protocols, network security protocols, and other factors. Additional embodiments and/or examples relating to computer networks are described below in Section 8, titled “Computer Networks and Cloud Networks.”

As illustrated in FIG. 1, example system 100 includes an access provider 110, an access management device 120, a client device 130, and various components thereof that may be utilized for providing secure access to a wireless network. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, the example system 100 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In an embodiment, access provider 110 may provision access to a computer network such as a wireless network. For example, access provider 110 may provide network access to a client device 130. Access provider 110 may be a digital device such as a networking device. The term “networking device” may generally refer to any device that plays a role in facilitating communication, data exchange, and/or connectivity to or within a computer network. Examples of common networking devices include routers, switches, hubs, wireless access points, modems, and many others. Access provider 110 may communicate or otherwise interact with nodes outside of system 100. For example, access provider 110 may forward data packets between the computer network and, for instance, a remote web server. Access provider 110 may also communicate or otherwise interact with access management device 120, client device 130, other components of system 100, and users of the system 100. As illustrated in FIG. 1, access provider 110 may include credentials generator 112, data repository 114, credentials manager 116, and/or other components. The components of access provider 110 may communicate with any other component of system 100, a user of system 100, and/or nodes outside of system 100.

In an embodiment, credentials generator 112 may generate user credentials to connect to a computer network. Credentials generator 112 may generate user credentials according to various techniques. User credentials may be configured, for example, in accordance with a target access configuration. Credentials generator 112 may generate more than one set of user credentials in a single credentials-generation operation. Generated user credentials may include an encryption key(s). Additionally, or alternatively, the user credentials may be configured such that one or more encryption keys may be derived from the user credentials. Credentials generator 112 may include/provide other information in addition to user credentials. For example, credentials generator 112 may also provide a network identifier to be used in association with user credentials. Credentials generator 112 may further provide an encryption key(s) that is separate from any that may be included within the user credentials or derived from the user credentials. Credentials generator 112 may be configured to generate user credentials in response to various triggers, conditions, events, etc. For example, credentials generator 112 may generate user credentials in response to access provider 110 receiving a request for credentials, in response to being queried to generate credentials by a component of the system 100 (e.g. credentials manager 116), in response to being queried to generate credentials by a user of the system 100, and/or in response to other triggers, conditions, events, etc.

Credentials generator 112 may store the generated user credentials in data repository 114. Additionally, or alternatively, credentials generator 112 may send generated user credentials to credentials manager 116 or to another component of system 100. If the credentials generator 112 is implemented on the access management device 120, the credentials generator 112 may (a) store the credentials on the access management device 120 and/or (b) transmit the credentials to the access provider 110. Credentials generator 112 may be unutilized or excluded from system 100 in some embodiments. For example, credentials generator 112 may be unutilized or excluded from system 100, if a user defines one or more sets of user credentials that are to be used for every attempted authentication. Additional embodiments and/or examples relating to the generating of user credentials are described below in Section 3, titled “Operations for Providing Secure Network Access.”

In an embodiment, data repository 114 may store user credentials. The user credentials stored in data repository 114 may originate from various sources. For example, data repository 114 may contain user credentials that were generated by credentials generator 112. created by another component of the system 100, created by a component outside of the system 100, were defined by a user of the system 100, and/or that originate from elsewhere. In addition to storing user credentials, data repository 114 may store other information as well. Other information stored in data repository 114 may include, for example, target access configurations, network identifiers, separate encryption keys, and other information.

In an example, credentials manager 116 may query credentials generator 112 to generate user credentials. Credentials manager 116 may receive generated user credentials from credentials generator 112. Credentials manager 116 may send generated credentials to other components of the system 100 and/or credentials manager 116 may store user credentials and other information in data repository 114. Credentials manager 116 may also retrieve user credentials and other information from data repository 114. Credentials manager 116 may be configured to respond to credentials requests received by access provider 110. For example, when access provider 110 receives a credentials request, credentials manager 116 may query credentials generator 112 to generate user credentials and/or retrieve user credentials from data repository 114. Additionally, or alternatively, credentials manager 116 may be configured to determine when to query credentials generator 112 to generate new user credentials according to one or more rules, triggers, conditions, and/or events. For example, credentials manager 116 may query credentials generator 112 to generate user credentials in response to the passage of a certain period of time, in response to access provider 110 having received a certain number of credentials requests, in response to access provider 110 receiving a suspicious authentication request, in response to system 100 detecting other suspicious activity, or in response to other rules, triggers, conditions, and/or events. Credentials manager 116 may also be configured to perform one or more additional operations that, for example, may be necessary for authenticating a client device. For example, any user credentials sent from access provider 110 in response to a credentials request, may also be stored in data repository 114 by credentials manager 116. When access provider 110 receives a request to authenticate a digital device based on a set of user credentials, the credentials manager 116 may compare the received set of user credentials with user credentials stored in data repository 114. Credentials manager 116 may also be configured to delete the user credentials stored in data repository 114 periodically or according to one or more other rules, triggers, conditions, or events.

In an embodiment, access management device 120 may manage the process for establishing access between a computer network and a client device 130. Access management device 120 may communicate or otherwise interact with access provider 110, client device 130, other components of system 100, user of system 100, and nodes outside of system 100. Access management device 120 may, for example, be a digital device such as a POS terminal. Examples of POS terminals include cash registers, checkout kiosks, pin pads, laptops, tablets, smart phones, and others. As illustrated in FIG. 1, access management device 120 may include credentials requestor 122, image generator 124, and image publisher 126, and/or other components. The components of access management device 120 may communicate with any other component of system 100, a user of system 100, and/or nodes outside of system 100.

In an embodiment, credentials requestor 122 may request credentials from the access provider 110. Credentials requestor 122 may, for example, include in the credentials request a target access configuration. A target access configuration may define permissions, security settings, network configurations, authentication methods, and/or other parameters that control how an authorized device may interact with the computer network. In an example, a target access configuration may stipulate that the computer network access provided to an authenticated client device 130 is to be terminated after a certain period of time. In another example, the target access configuration might specify the number of devices that may be authenticated using a set of user credentials. The target access configuration parameters may be defined or modified by a component of the system 100, by a user of system 100, and/or a node outside of system 100.

In an embodiment, image generator 124 generates image key(s) 142 that embed information. The term “image key” may generally refer to data existing in a digital medium or it may refer to a corresponding visual representation of that data (e.g. an image printed on a receipt). An image key(s) 142 may embed information such as, for example, user credential(s) 140, network identifiers, separate encryption keys, and other information. Image key(s) 142 may be generated by image generator 124 according to a variety of formats such as, for example, QR codes, bar codes, 2D bar codes, text-based codes, data matrix codes, non-fungible tokens, and various others.

In an embodiment, image publisher 126 may publish an image key(s) 142 by various means. Image publisher 126 may, for example, cause an image key(s) 142 to printed, displayed, projected, embedded, transmitted, or otherwise presented. In an example, image publisher 126 may cause the image key(s) 142 to be printed to a physical medium such as, for instance, a paper receipt. The receipt may be printed by a receipt printer included in or in communication with the access management device 120. Image key(s) 142 may be printed in a manner that results in the image key(s) 142 only being temporarily visible upon a physical medium. For example, image key(s) 142 might be printed to a coffee sleeve with irreversible thermochromic ink. In response to heat transfer from, for example, a cup of coffee, image key(s) 142 may fade such that it can no longer be scanned by a device. In another example, image publisher 126 may cause an image key(s) 142 to be displayed on digital display. The digital display may be included in the access management device 120 or any other digital device. The digital display may be part of an interface such as, for example, a graphical user interface (GUI). Image publisher 126 may publish or present the image key(s) 142 in a manner that is accessible and/or visible to only a targeted recipient (e.g., a particular customer at a coffee shop). Alternatively, or in addition, image publisher 126 may cause the image key(s) 142 to be projected to a surface such as, for example, a screen, wall, or counter.

Image publisher 126 may also be configured to publish an image key(s) 142 via one or more wired or wireless transmissions. For example, image publisher 126 may be configured to publish an image key(s) 142 via a transmission that accords to near field communication protocols. Near field communication (NFC) refers to a set of communication protocols that enable short-range wireless communications between NFC-enabled devices. NFC technology is commonly employed to allow for contactless communication between digital devices, such as smartphones, tablets, smart cards, and other NFC devices. The term “NFC-enabled device” or “NFC device” may generally refer to any device configured to communicate according to NFC protocols. Devices configured to communicate according to NFC protocols include passive devices and active devices. A passive device may include a microchip and an antenna but no power source. In contrast, an active device is a device that includes a power source. Passive devices may contain some amount of data and they rely on energy emitted from an active device to communicate that data. For example, an active device may emit a radio frequency (RF) field. The RF field contains energy that may be picked up by the antenna of a passive device that is in proximity with the active device. This energy may be used to briefly power the passive device's microchip and allow it to communicate with the active device. Active devices may also communicate with other active devices. Communications between two active devices may allow for complex interactions and bidirectional data exchange. System 100 might incorporate both active and passive devices. In an example, image publisher 126 may publish an image key(s) 142 by encoding the image key(s) 142 into a passive NFC device. A passive NFC device may also be referred to as an NFC tag. The passive NFC device may be included within the access management device 120 or the passive NFC device may be included within some other physical medium such as, for example, a poster, a coffee sleeve, a menu or menu holder, a coaster, etc. In another example, image publisher 126 may be an active NFC device. In this way, image publisher 126 may directly transmit the image key(s) 142 to NFC devices in close proximity to access management device 120. NFC protocols are just one of many example communication protocols. It should be understood that active and passive devices configured according to various communication protocols may be included in system 100 and may perform the operations herein described.

In an embodiment, client device 130 may be a digital device seeking to connect to the computer network. For example, client device 130 may be smart phone, tablet, laptop, or any other digital device. An embodiment may include an application executed by client device 130. Client device 130 may communicate with access provider 110, access management device 120, other components of system 100, a user of system 100, and/or nodes outside of system 100. As illustrated in FIG. 1, client device 130 may include a camera 132, an NFC component 134, a credentials extractor 136, data repository 138, and/or other components. Data repository 138 may include user credential(s) 140, image key(s) 142, and other information. Any component of client device 130 may communicate with any other component of system 100, a user of system 100, and/or a node outside of system 100.

In an embodiment, camera 132 may be an image sensor that captures light and converts it into digital information corresponding to an image. Client device 130 may receive image key(s) 142 by using camera 132 to capture an image of an image key(s) 142 presented by image publisher 126. For example, client device 130 may receive image key(s) 142 by capturing an image of a QR code that was printed on a receipt. Image key(s) 142 captured by camera 132 may be sent to credentials extractor 136 or stored in data repository 138. In some embodiments, client device 130 may not include a camera 132. Camera 132 may be included in another digital device that may communicate with client device 130. For example, the client device 130 may be a laptop that lacks a suitable camera. A user may capture image key(s) 142 with another digital device (e.g. a smartphone with a camera) and transmit the image key(s) 142 to the laptop client device 130. Additionally, or alternatively to camera 132, another sensor suitable for capturing image key(s) 142 may be used such as, for example, an optical scanner, a barcode scanner, a QR code scanner, infrared scanners, and/or other sensors. In some embodiments, client device 130 may receive image key(s) 142 in the form of a text-based code through the input of a user of system 100. The text-based code may be received through a GUI or other interface of the client device 130. Additionally, or alternatively, client device 130 may rely on other mechanisms for receiving image key(s) 142 such as, for example, NFC component 134.

In an embodiment, credentials extractor 136 may extract credential(s) 140 as well as other information from image key(s) 142. Credentials extractor 136 may include software that locates an image key(s) 142 within a captured image and that identifies patterns, codes, etc. that correspond to embedded information. The software corresponding to credentials extractor 136 may, for example, be included as standard within client device 130 and/or be included within an application installed on the client device 130. Credentials extractor 136 may retrieve image key(s) 142 from data repository 138. Credentials extractor 136 may also receive image key(s) 142 from camera 132 and NFC component 134. Credentials extractor 136 may store extracted credential(s) 140 in data repository 138 and/or credentials extractor 136 may send extracted credential(s) 140 to NFC component 134 or elsewhere.

In an embodiment, NFC component 134 may be used to communicate with other NFC devices. For example, the NFC component 134 may be utilized to retrieve image key(s) 142 that have been encoded to a passive NFC device. Additionally, or alternatively, NFC component 134 may receive image key(s) 142 and/or credentials 140 through an NFC transmission originating from another NFC device. In an example, NFC component 134 may be substituted or supplemented with components configured according to various other communication protocols. In certain examples, NFC component 134 may be unutilized or excluded from system 100.

In an embodiment, a data repository (e.g., data repository 114 and data repository 138) may be any type of storage unit and/or device (e.g., a file system, database, collection of tables, or any other storage mechanism) for storing data. Data repository 114 and/or data repository 138 may include multiple different storage units and/or devices. The multiple different storage units and/or devices may or may not be of the same type or located at the same physical site. Data repository 114 may be implemented or executed on the same computing system as access management device 120, client device 130, and/or other components of system 100. Alternatively, or additionally, data repository 114 may be implemented or executed on a computing system separate from access provider 110. Data repository 114 may be communicatively coupled to access provider 110 via a direct connection or via a network. Data repository 138 may be implemented or executed on the same computing system as access provider 110, access management device 120, and/or other components of system 100. Alternatively, or additionally, data repository 138 may be implemented or executed from a computing system separate from client device 130. Data repository 138 may be communicatively coupled to client device 130 via a direct connection or via a network.

In one or more embodiments, information describing user credential(s) 140 and image key(s) 142 may be implemented across any of the components within system 100. However, this information is illustrated within data repository 138 for purposes of clarity and explanation.

In one or more embodiments, an interface (not shown) refers to a display that facilitates communications between a user and system 100 including access provider 110, access management device 120, client device 130, and/or any other digital device. An interface implemented on client device 130 may display an image currently being captured by camera 132. For example, the interface allows a user to position the client device 130, and thereby the camera 132, to capture an image of the image key(s) 142 that is printed on a receipt.

An interface may render user interface elements and receive input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of an interface may be specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, an interface is specified in one or more other languages, such as Java, C. or C++.

### 3. Operations for Providing Secure Network Access

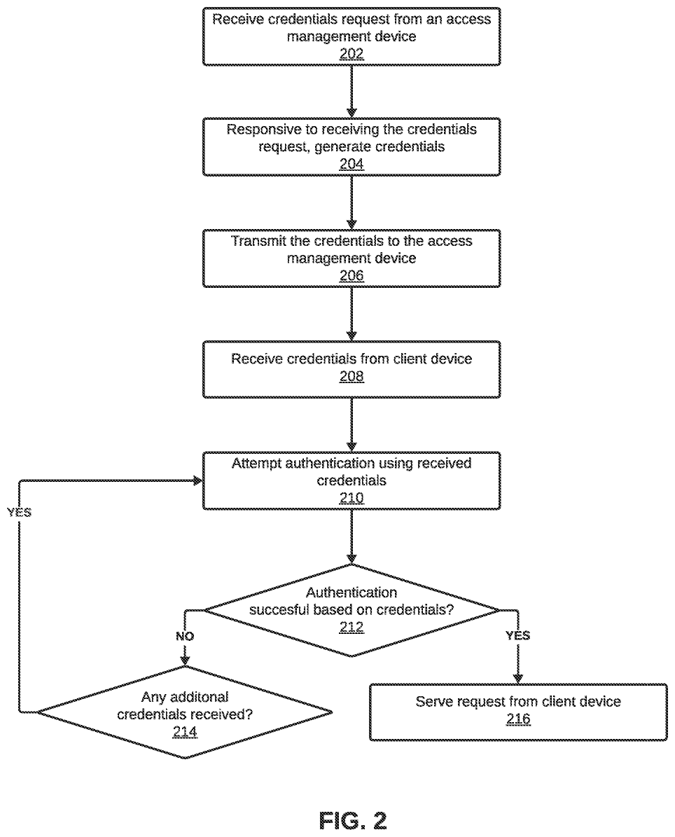

FIG. 2 illustrates an example set of operations for providing secure network access in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments. The operations below are described with reference to an access provider; however, other components of the system may execute one or more of the operations described below.

In operation 202, an access provider may receive a request from an access management device for user credentials that may be used to access a computer network such as a wireless network. The credentials request may be transmitted with additional information such as a target access configuration.

In operation 204, the access provider may generate user credentials for connecting to the computer network in response to receiving the credentials request from the access management device in operation 202. Credentials may be generated according to various techniques. For example, user credentials may be generated by iterative processes, pseudorandom processes, random processes, other processes, or a combination thereof. The credentials generation process may depend upon numerous factors such as, for example, communication protocols, security protocols, and other factors. While generating user credentials, the access provider may configure the user credential in accord with a target access configuration. For example, configuring the credentials in accordance with a target access configuration may result in a subsequent connection with a client device being terminated after a period of time. In another example, the user credentials may be configured such that they can only be used to authenticate a single digital device. Alternatively, the user credentials may be configured such that a single set of user credentials can be used to authenticate multiple digital devices. The access provider may generate multiple sets of user credentials during a single operation. The credentials generation process may not necessarily include the creation of new user credentials. For example, generating credentials might simply entail selecting a set of user credentials from a list of sets of user credentials. Generating user credentials may also entail providing a network identifier to be used in association with the user credentials. For example, if the wireless network is a Wi-Fi network, the access provider may also provide an SSID to be used in association with the user credentials. The generated user credentials may include one or more encryption keys. Additionally, or alternatively, the generated user credentials may be configured such that one or more encryption keys may be derived from the user credentials. Additionally, or alternatively, the credentials generation process may include generating separate encryption keys apart from those that may be included in or derived from the user credentials. Different encryption keys may be generated for different purposes. For example, one encryption key may be generated for encrypting initial communications, and another encryption key may be generated for encrypting subsequent communications.

In operation 206, the access provider may transmit user credentials to an access management device in response to the credentials request that was received by the access provider in operation 202. The user credentials that are transmitted to the access management device may be the same or different from the user credentials that were generated in operation 204. Other information may also be transmitted with the user credentials to the access management device. For example, the access provider may also transmit a network identifier(s), separate encryption key(s), and/or other information with the user credentials.

In operation 208, the access provider may receive the user credentials that were previously transmitted by the access provider. For example, the access provider may receive user credentials from a client device along with a request to be authenticated based on the user credentials. It may be that the user credentials that are received by the access provider are identical to user credentials that were transmitted by the access provider to the access management device in operation 206.

In operation 210, the access provider may attempt to authenticate a client device based on user credentials that are received from the client device in operation 208. The procedure for attempting to authenticate a client device may vary according to a wide variety of factors. For example, the authentication procedure may vary according to communication protocols, security protocols, and other factors.

In operation 212, the access provider may determine whether to proceed to another operation based on the status of an attempted authentication. For example, the access provider may proceed to operation 214 if the attempted authorization of operation 210 was not successful (NO in operation 212). If the attempted authorization of operation 210 was successful (YES in operation 212), the access provider may proceed to operation 216.

In operation 214, the access provider may determine if any additional user credentials were received from a device. For example, the access provider may determine if any additional user credentials were received from a client device other than user credentials that were used during a failed authentication attempt in operation 210. If the access provider determines that additional user credentials were received (YES in operation 214), the access provider may return to operation 210. That is, the access provider may make another attempt to authenticate the client device based on the additional user credentials.

In operation 216, the access provider may serve a request from a device. For example, the access provider may serve a request from a client device that was successfully authenticated in operation 210.

### 4. Operations for Managing Secure Network Access

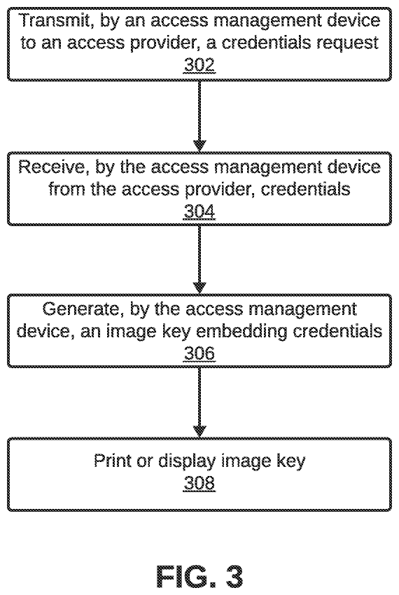

FIG. 3 illustrates an example set of operations for managing network access in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments. The operations below are described with reference to an access management device; however, other components of the system may execute one or more of the operations described below.

In operation 302, an access management device may transmit a credentials request to the access provider. The credentials request may be a request for one or more sets of user credentials. A target access configuration may be included with the credentials request. A target access configuration may define permissions, security settings, network configurations, authentication methods, and/or other parameters that control how an authorized device may interact with the computer network. For example, a connection corresponding to the target access configuration may be terminated by the access provider after a period of time or in the event of some other condition.

In operation 304, the access management device may receive user credentials from the access provider. The access management device may receive multiple sets of user credentials. The access management device may also receive other information such as a network identifier(s), a separate encryption key(s), and/or other information. The network identifier may be, for example, an SSID.

In operation 306, the access management device may generate an image key that embeds the user credentials that were received in operation 304. The image key may be generated according to a variety of formats such as, for example, a QR code, a bar code, a 2D bar code, a text-based code, a data matrix code, a non-fungible token, or any other form of image or code capable of embedding the credentials. Additional information may also be embedded within the image key such as, for example, a network identifier(s), a separate encryption key(s), or other information.

In operation 308, the access management device may communicate the image key to another component of the system. For example, the image publisher of the access management device may cause the image key to be displayed, printed, or projected to a surface. For instance, the image key might be printed to a receipt or displayed on a digital display. Additionally, or alternatively, the image publisher may cause the image key to be directly or indirectly transmitted to a device. For example, the image publisher may encode the image key to a passive device such as a passive NFC device. An active NFC device in close proximity to the passive NFC device will be able to retrieve the data encoded to the NFC device. The image key may also be directly transmitted from the access management device to a client device.

### 5. Operations for Requesting Secure Network Access

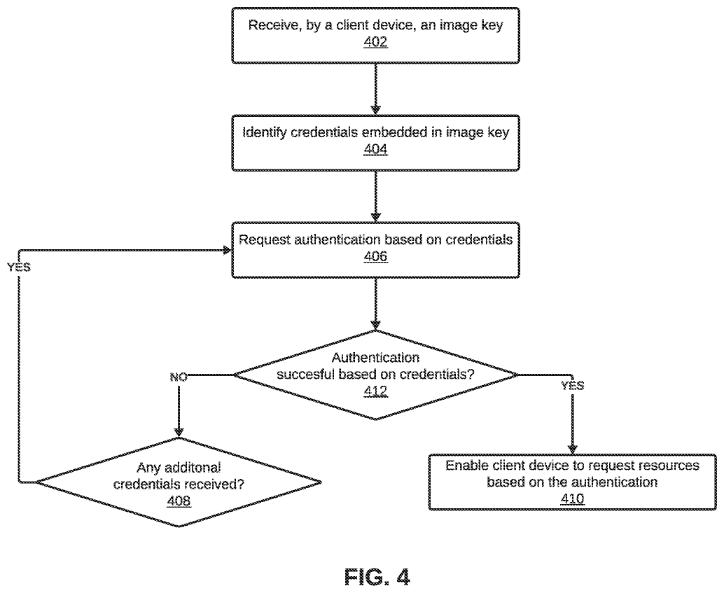

FIG. 4 illustrates an example set of operations for requesting network access in accordance with one or more embodiments. One or more operations illustrated in FIG. 4 may be modified, rearranged, or omitted all together. Accordingly, the particular sequence of operations illustrated in FIG. 4 should not be construed as limiting the scope of one or more embodiments. The operations below are described with reference to a client device; however, other components of the system may execute one or more of the operations described below.

In operation 402, a client device may receive an image key. For example, the client device may use a camera to scan an image key that has been displayed, printed, or projected onto a surface. For example, the image key may be scanned from a paper receipt or from a digital display. A camera may be supplemented or substituted with a variety of other sensors that are suitable for scanning an image key. Additionally, or alternatively, the client device may receive the image key through a wired or wireless transmission. For example, the client device might receive an image key through an NFC component included in the client device.

In operation 404, the client device may extract credentials that are embedded in an image key. For example, software executed by the client device may identify/extract user credentials that are embedded in an image key that was received in operation 402. The software enabling the client device to identify and extract credentials from the image key may be functionality that is standard to the client device, or it may be supplied by an application that is installed on the client device. Additional information may also be extracted from the image key such as a network identifier(s), a separate encryption key(s), and/or other information.

In operation 406, the client device may request authentication from the access provider based on user credentials that were extracted from an image key in operation 404. The client device may send one or more sets of user credentials within a single authentication request. The authentication request may be further based on additional information such as a network identifier. For example, if the wireless network is a Wi-Fi network, the authentication request may be further based on an SSID that was extracted from an image key in operation 404. The authentication request sent to the access provider may be encrypted according to one or more encryption keys. For example, the authentication request may be encrypted according to a pre-shared encryption key such as one that may have been embedded within an image key that was received in operation 402.

In operation 412, the client device may proceed to another operation based on the status of an attempted authentication. For example, if the authentication that was requested in operation 406 was unsuccessful (NO in operation 412), the client device may proceed to operation 408. If the requested authentication of operation 406 was successful (YES in operation 412), the client device may proceed to operation 410. Operation 412 is similar to operation 212 described above with reference to FIG. 2.

In operation 408, the client device may determine if any user credentials were received apart from the user credentials that were transmitted with the authentication request in operation 406. This operation may entail determining if there are any additional user credentials embedded in the image key that was received in operation 404. Additionally, or alternatively, this operation may entail determining if any additional image keys were received in operation 406. If a client device determines that additional user credentials were received (YES in operation 408), the client device may return to operation 406. That is, the client device may make another request for authentication to the access provider based on the additional user credentials.

In operation 410, the client device may be enabled to request resources. For example, software executed on the client device may enable the client device to request resources based on successful authentication. In embodiments, the software enabling the client device to request resources may be functionality that is standard to the client device, or it may be supplied by an application that is installed on the client device. Subsequent requests for resources by the client device may be encrypted. For example, subsequent requests for resources by the client device may be encrypted according to a pre-shared encryption key such as one that may have been included or derived from an image key that was received in operation 402. Additionally, or alternatively, subsequent requests may be encrypted according to an encryption key that was shared between the client device and the access provider at some point subsequent to an initial authentication request of operation 406.

### 6. Combined Operations for Secure Network Access

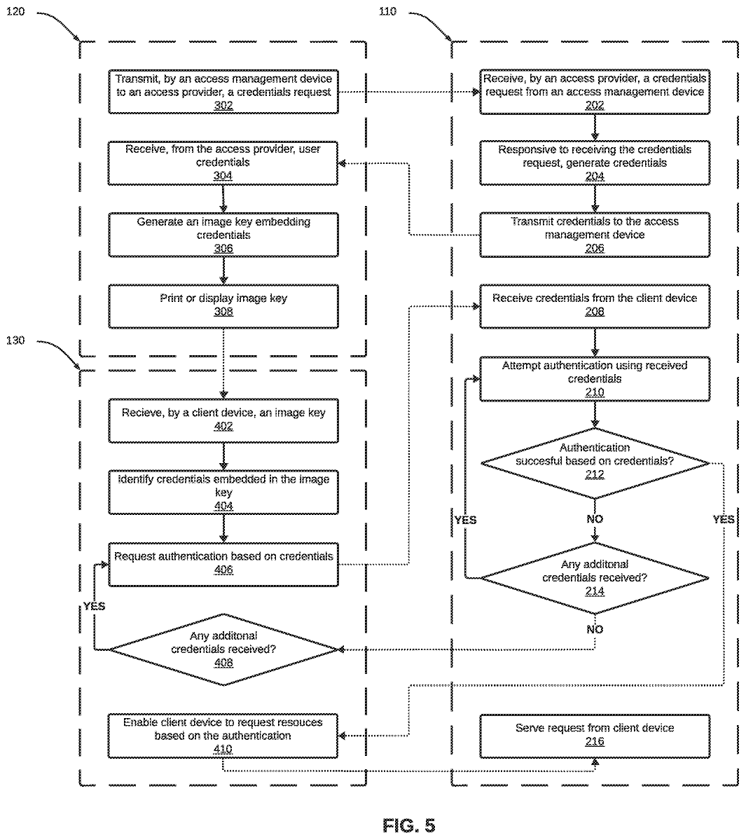

FIG. 5 illustrates an example set of operations performed by the system for securely accessing a computer network. One or more operations illustrated in FIG. 5 may be modified, rearranged, or omitted all together. Operations described below should be understood as a specific example which may not be applicable to certain embodiments. Accordingly, the particular sequence of operations illustrated in FIG. 5 should not be construed as limiting the scope of one or more embodiments.

In an embodiment, an access management device may transmit a credentials request to the access provider (operation 302). The access management device may transmit other information with the credentials request such as, for example, a target access configuration.

In operation 202, the access provider may receive a credentials request from the access management device. Included with the credentials request may be other information pertinent to credential generation. In response to receiving the credentials request from the access management device, the access provider may generate user credentials that may be used to access a secure computer network (operation 204). The credentials may be generated in accordance with a target access configuration or any additional information that was received in operation 202. In operation 206, the access provider may transmit user credentials to the access management device.

In operation 304, the access management device may receive user credentials that were transmitted from the access provider in operation 206. In operation 306, the access management device may generate one or more image keys embedding user credentials and additional information. An image key may embed one or more sets of user credentials. In operation 308, the access management device may then print, display, transmit, or otherwise present the image key. For example, the access management device may print an image key on a paper receipt or display an image key on a digital display.

In operation 402, a client device may receive an image key that is presented by the access management device. For example, the client device may receive an image key that is displayed on a digital display or printed on a receipt by scanning it with a camera that is included on the client device. In operation 404, software executed by the client device may identify/extract user credentials and additional information from an image key. In operation 406, a request to authenticate the identity of the client device may be sent from the client device to the access provider. The authentication request may include user credentials that were identified/extracted from the image key(s) received by the client device. The authentication request may be further based on additional information such as a network identifier. The authentication request may be encrypted according to one or more encryption keys.

In operation 208, the access provider may receive user credentials that are transmitted from a client device. For example, the access provider may receive user credentials within an authentication request that was sent from a client device. In operation 210, the access provider may attempt to authenticate the client device based on the user credentials received in operation 208. In operation 212, the access provider may proceed to an operation based on the status of the attempted authentication in operation 210. For example, if the attempted authorization of operation 210 was not successful (NO in operation 212), the access provider may proceed to operation 214. In operation 214, the access provider may determine if any additional user credentials were received from a client device other than any user credentials that were used during a failed authentication attempt in operation 210. If the access provider determines that additional user credentials were received (YES in operation 214), the access provider may return to operation 210. If the access provider determines that additional user credentials were not received (NO in operation 214), the client device may proceed to operation 408.

In operation 408, the client device may determine if any user credentials were received apart from the user credentials that were transmitted with the authentication request in operation 406. If a client device determines that additional user credentials were received (YES in operation 408), the client device may repeat operation 406 and the access provider may repeat operation 208, operation 210, and operation 212.

If any attempted authorization of operation 210 is successful (YES in operation 212), the client device may proceed to operation 410.

In operation 410, the client device may be enabled to request resources based on the authentication. The subsequent resource requests from the client device may be encrypted.

Finally, in operation 216, the access provider may serve a request from the client device.

### 7. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

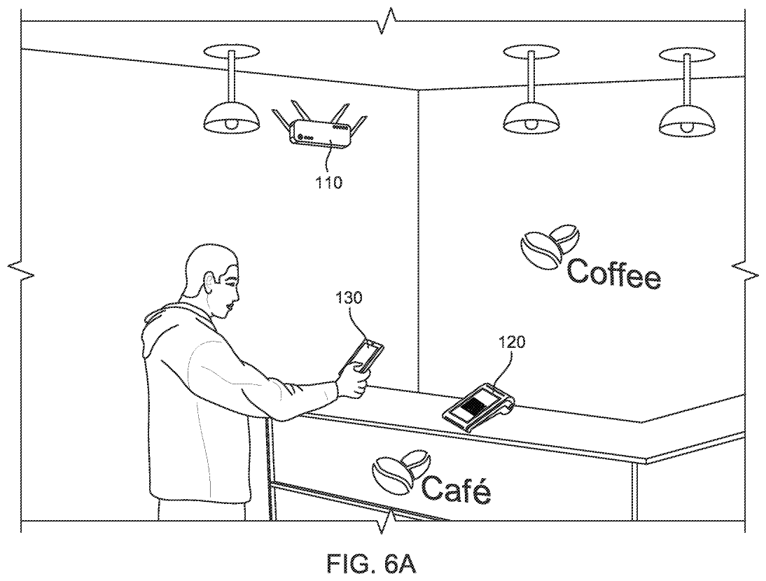

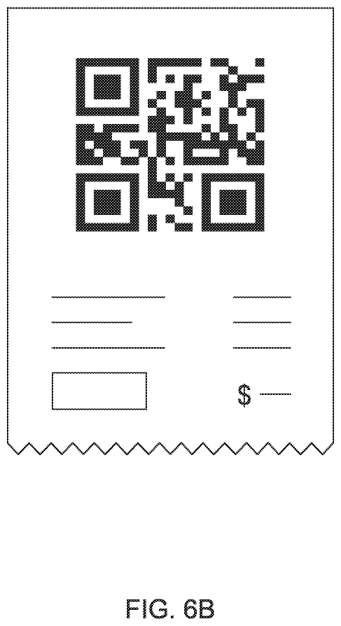

FIG. 6A illustrates a system 100 providing secure network access to a client device of the system. System 100 includes access provider 110, access management device 120, and client device 130. In the example embodiment illustrated in FIG. 6A, access provider 110 is a networking device such as a router, access management device 120 is a POS terminal, and the client device 130 is a smart phone with a camera. The operations of system 100 may be initiated by the access management device 120. For example, the access management device 120 may request user credentials from access provider 110 in response to the completion of a retail transaction through access management device 120. A “retail transaction” may refer to any commercial transaction that relates to a setting where network access may be offered. For example, the purchase of a cup of coffee may be referred to as a retail transaction. After receiving user credentials from the access provider 110, access management device 120 may present an image key embedding user credentials. For example, FIG. 6A illustrates an image key in the form of a QR code being presented to a user of the system 100 on a digital display.

FIG. 6A further illustrates a user of the system 100 using a camera of client device 130 to scan the QR code of the image key. After the client device 130 scans the image key, the client device 130 may request authentication from the access provider 110 based on the user credentials that were identified within the QR code. Following a successful authentication, the client device 130 may be enabled to request resources based on the authentication. The access provider 110 may then serve requests from the client device 130.

FIG. 6B illustrates an image key according to an example embodiment. The image key illustrated in FIG. 6B is in the format of QR code that has been printed to a paper receipt. The paper receipt may have been printed in response to a retail transaction that was completed through the access management device.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### 9.1 Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally, or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 9.2 Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Advantages of Secure Network Access

Entities such as business establishments and other organizations commonly provide public internet access through a wireless network. Access to these wireless networks is often severely under protected. For example, it may be that a wireless network does not require any authentication and data traffic over the network might be unencrypted (e.g. an “open” Wi-Fi network). In this example, it may be possible for one client device that is connected to the network to see all communications that are sent by another client device connected to the network. These communications might include login credentials, personal information, financial data, or other sensitive information. Fortunately, many public wireless networks require some form of authentication before provisioning network access and encrypt data traffic. However, even with these measures in place significant vulnerabilities remain. The present disclosure addresses these existing vulnerabilities.

The presently disclosed mechanism for providing secure network access maximizes the benefits of network authentication without the need for any intervention on the part of the entity that is administering the wireless computer network. In general, requiring authentication helps restrict network access to authorized users. Without authentication procedures, any device in the vicinity of the wireless network may access the network and linger for so long as they wish to continue to engage in malicious activity. Moreover, authentication procedures also help with bandwidth management.

Consider, for example, a business establishment that offers free internet access through a password-protected wireless network. Password protection would most benefit network security if the password is regularly changed and is distributed to only trusted users. However, the operators of the business may not be aware of best practices for good network security nor the risks that are associated with poor network security. Moreover, the business establishment may entertain many customers who wish to access the wireless network in a single day, and it may be too much to ask of the operators of the business establishment to closely guard the password. Consequently, the password may go unchanged for long periods of time, and it may be prominently displayed in a location where it can be seen by anyone who visits the establishment. In this scenario, whatever benefits that might have been gained by the password protection have been seriously diminished.

The present disclosure addresses these shortfalls by relieving network administrators of the responsibility for guarding network access. The present disclosure provides mechanisms for provisioning network access, changing login credentials, monitoring network access, and dispelling unwanted connection all without the need for any intervention on the part of the entity that is administering the network. For example, the provisioning of network access may be tied to an event such as a retail transaction. Internet access might be the subject of the retail transaction and/or the subject of the retail transaction might be some other good or service such as, for example, a cup of coffee. Upon the occurrence of the retail transaction or event, an image key may be automatically provided that embeds user credentials that may be used to access the wireless network. New user credentials may be generated for every image key. The user credentials embedded within the image key may only be valid for a certain period of time. The user credentials may further be configured such that they may only be used by a set number of client devices to access the wireless network. A network connection to an authenticated client device may be configured such that it is terminated after a set period of time. Moreover, the system may be configured to terminate a network connection upon the detection of suspicious network activity on the part of a connected client device. In this way, the present disclosure maximizes the benefits that may be gained by requiring network authentication without the need for any intervention on the part of the entity that is administering the wireless computer network.

The presently disclosed mechanism for providing secure network access also maximizes the benefits of encrypting network data traffic by encrypting all communications between client devices and the access provider. Encryption is crucial for network security because it prevents a malicious actor from reading communications sent from a client device over the wireless network. However, existing mechanisms for establishing a connection to a public wireless computer network generally require that at least the initial communications between a client device and an access provider are unencrypted.

The initial communications between a client device and an access provider generally contain the information that is necessary for a client device to establish and maintain a connection with the wireless network. For example, initial communications from the access provider to the client device might include a network identifier such as an SSID. The network identifier may be necessary for any client device to request authentication. Initial communications from a client device to an access provider, for example, might include an authentication request that is based on login credentials and the network identifier. The initial communications between the access provider and the client device generally need to be unencrypted because the client device generally does not have access to the necessary encryption key until after it has been successfully authenticated. Because these communications are unencrypted, they may be exploited by a malicious actor in a variety of ways.

The present disclosure addresses this vulnerability by embedding within the image key all the information that will be needed to encrypt communications from the start. For example, the image key may embed the network identifier. Because the image key embeds the network identifier, the access provider will not need to broadcast the network identifier in an unencrypted communication and devices that have not received an image key may be significantly limited in their ability to interact with the access provider. The image key may also embed information that is necessary for the client device to encrypt its initial communications to the access provider. For example, one or more encryption keys may be embedded in an image key. Additionally, or alternatively, one or more encryption keys may be shared between a client device and an access provider during or after the initial communications.

### 11. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

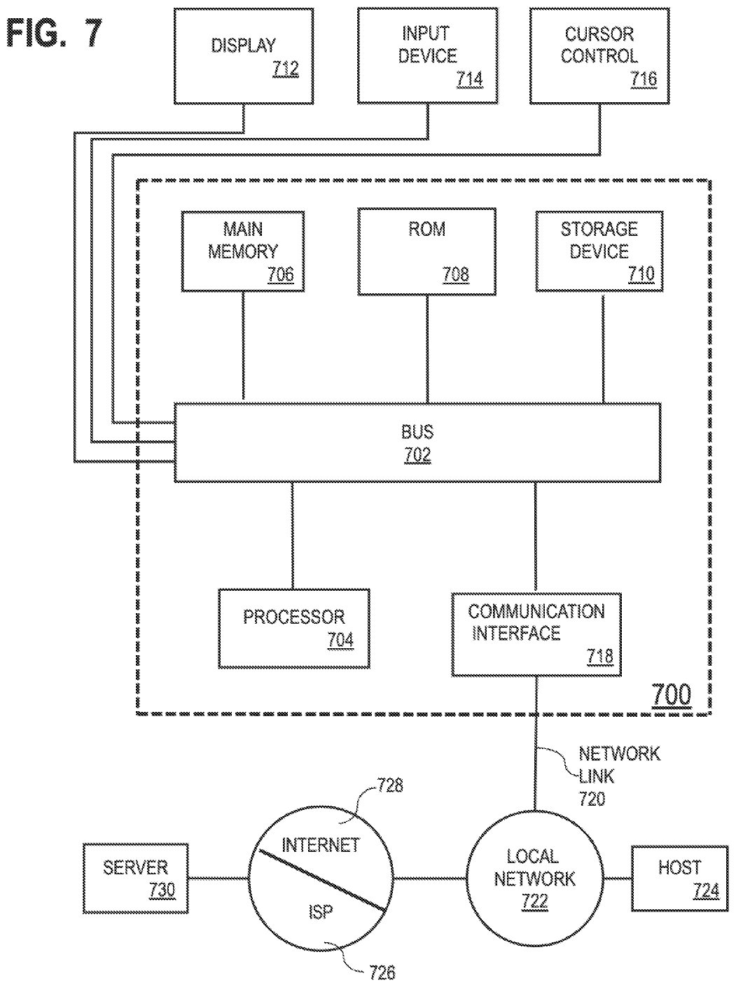

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### 12. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media comprising instructions which, when executed by one or more hardware processors, cause performance of operations comprising:
transmitting, by an access management device, a credentials request for user credentials to connect to a wireless network;
receiving, by the access management device, a first set of user credentials;
generating an image key embedding the first set of user credentials; and
printing or displaying the image key.

2. The one or more non-transitory computer-readable media of claim 1, wherein receiving the first set of user credentials further comprises: receiving a network identifier to be used in association with the first set of user credentials, and wherein generating an image key embedding the first set of user credentials further comprises: embedding the network identifier to be used in association with the first set of user credentials.

3. The one or more non-transitory computer-readable media of claim 2, wherein the wireless network is a Wi-Fi network and wherein the network identifier is a service set identifier (SSID).

4. The one or more non-transitory computer-readable media of claim 1, wherein the operations further comprise generating a target access configuration and transmitting the target access configuration with the credentials request and wherein the target access configuration is configured to terminate a connection with the first client device after a period of time.

5. The one or more non-transitory computer-readable media of claim 1, wherein the first set of user credentials are valid for authenticating a plurality of client devices.

6. The one or more non-transitory computer-readable media of claim 1, wherein the first set of user credentials are only valid for authenticating a single client device.

7. The one or more non-transitory computer-readable media of claim 1, wherein receiving, by the access management device, comprises: receiving a first set of user credentials and a second set of user credentials, and wherein generating an image key embedding the first set of user credentials comprises: generating an image key embedding the first set of user credentials and the second set of user credentials.

8. The one or more non-transitory computer-readable media of claim 1, wherein the image key embedding the first set of user credentials is a QR code, a bar code, or a text-based code.

9. One or more non-transitory computer-readable media comprising instructions which, when executed by one or more hardware processors, cause performance of operations comprising:
receiving, from an access management device, a credentials request for user credentials to connect to a wireless network;
responsive to the credentials request:
generating a first set of user credentials for connecting to the wireless network;
transmitting, to the access management device, the first set of user credentials;
receiving, from a first client device, the first set of user credentials, wherein the first client device is different than the access management device;
authenticating the first client device based on the first set of user credentials; and
subsequent to authenticating the first client device based on the first set of user credentials, serving a first set of requests from the first client device.

10. The one or more non-transitory computer-readable media of claim 9, wherein generating the first set of user credentials further comprises: assigning a network identifier to be used in association with the first set of user credentials, and wherein transmitting the user credentials further comprises: transmitting the network identifier to be used in association with the first set of user credentials.

11. The one or more non-transitory computer-readable media of claim 9, wherein the operations further comprise: receiving a target access configuration with the credentials request, wherein the first set of user credentials are configured in accordance with the target access configuration, and wherein a connection with the first client device is terminated after a period of time based on the target access configuration.

12. The one or more non-transitory computer-readable media of claim 9, wherein the first set of user credentials are valid for authenticating a plurality of client devices, and wherein the operations further comprise:
receiving, from a second client device, the first set of user credentials;
authenticating the second client device based on the first set of user credentials; and
subsequent to authenticating the second client device, serving a second set of requests from the second client device.

13. The one or more non-transitory computer-readable media of claim 9, wherein the first set of user credentials are only valid for authenticating a single client device.

14. The one or more non-transitory computer-readable media of claim 9, wherein the operations further comprise:
further responsive to the credentials request:
generating a second set of user credentials for connecting to the wireless network;
transmitting the second set of user credentials; and
prior to receiving the first set of credentials:
receiving, from the first client device, the second set of user credentials;
attempting to authenticate the first client device based on the second set of user credentials;
failing to authenticate the first client device based on the second set of user credentials.

15. One or more non-transitory computer-readable media comprising instructions which, when executed by one or more hardware processors, cause performance of operations comprising:
receiving an image key scanned by a first client device;
responsive to receiving the image key, configuring a connection between a wireless network and the first client device based on information embedded in the image key by:
identifying a first set of user credentials embedded within the image key;
requesting authentication for the wireless network based on the first set of user credentials; and
subsequent to authentication of the first client device based on the first set of user credentials, enabling the first client device to request resources over the wireless network.

16. The one or more non-transitory computer-readable media of claim 15, wherein responsive to receiving the image key, configuring a connection between a wireless network and the first client device based on information embedded with the image key further comprises:
prior to requesting authentication for the wireless network based on the first set of user credentials:
identifying a second set of user credentials embedded within the image key;
requesting authentication for the wireless network based on the second set of user credentials, wherein the authentication based on the second set of user credentials fails.

17. The one or more non-transitory computer-readable media of claim 15, wherein the information embedded within the image key further comprises: a network identifier to be used in association with the first set of user credentials.

18. The one or more non-transitory computer-readable media of claim 15, wherein the operations further comprise:
receiving the image key scanned by a second client device;
responsive to receiving the image key, configuring a connection between the wireless network and the second client device based on information embedded in the image key by:
identifying the first set of user credentials embedded with the image key;
requesting authentication for the wireless network based on the first set of user credentials; and
subsequent to authentication of the second client device based on the first set of user credentials, enabling the second client device to request resources over the wireless network.

19. The one or more non-transitory computer-readable media of claim 15, wherein the first set of user credentials are only valid for authenticating a single client device.

20. The one or more non-transitory computer-readable media of claim 15, wherein the image key is a QR code, bar code, or text-based code.
